(19) United States
(12) Patent Application Publication
(10) Pub. No.: US 2020/0389506 A1
(43) Pub. Date: Dec. 10, 2020

(54) VIDEO CONFERENCE DYNAMIC GROUPING OF USERS

(71) Applicant: International Business Machines Corporation, Armonk, NY (US)

(72) Inventors: Sarbajit K. Rakshit, Kolkata (IN); John M. Ganci, JR., Raleigh, NC (US); James E. Bostick, Cedar Park, TX (US); Martin G. Keen, Cary, NC (US)

(21) Appl. No.: 16/430,472

(22) Filed: Jun. 4, 2019

(51) Int. Cl. H04L 29/06; H04N 7/15; H04L 29/08; G06K 9/00

(52) U.S. Cl. CPC H04L 65/403; H04N 7/152; G06K 9/00228; H04L 65/1083; H04L 67/22

(57) ABSTRACT

A video conference is determined. The video conference includes a first user and a plurality of participants. A first group of participants is determined from the plurality of participants by at least one preference of the first user, the historical data for the first user, and the determined plurality of participants. A template for the video conference is created. The template displays at least the first group of participants. The template is displayed in the user interface of the video conference.

### BACKGROUND

The present invention relates generally to the field of video conferencing, and more particularly dynamically creating sub groups of visible users in a video conference.

Video conferencing allows for the reception of transmission of audio-video signals by multiple users using multiple devices in multiple locations. In simplest terms, a video conference is an organization or group meeting that takes place using audio-video signals. Often the video conferencing is done using computing devices, such as a personal computer or laptop, however, mobile platforms and other computing devices can also perform video conferencing.

Video conferencing can be between two users. However, video conferencing can be between hundreds, thousands, or even more users. Additionally, video conferencing has made its way into the personal world for conversation between friends and family. At the same time, video conferencing has made a major impact on the corporate world, allowing for communication between large numbers of individuals that may not be all located in the same location.

### SUMMARY

Embodiments of the present invention include a computer-implement method, computer program product, and system for video conferencing. In one embodiment, a video conference is determined. The video conference includes a first user and a plurality of participants. A first group of participants is determined from the plurality of participants by at least one preference of the first user, the historical data for the first user, and the determined plurality of participants. A template for the video conference is created. The template displays at least the first group of participants. The template is displayed in the user interface of the video conference.

### BRIEF DESCRIPTION OF THE DRAWINGS

FIG. 1 is a functional block diagram of a network computing environment, generally designated 100, suitable for operation of video conference program 112 in accordance with at least one embodiment of the invention.

FIG. 2 is a flow chart diagram depicting operational steps for a video conference program 112, in accordance with at least one embedment of the invention.

FIG. 3 is a block diagram depicting components of a computer, generally designated 300, suitable for executing video conference program 112, in accordance with at least one embodiment of the invention.

### DETAILED DESCRIPTION

Video conferencing allows for the reception of transmission of audio-video signals by multiple users using multiple devices in multiple locations. However, with the constantly changing sizes of video conferences and especially large groups in video conferences it is hard to manage who should be visible from the video conference to the user of a video conference program. Embodiments of the present invention recognize the need to streamline and modify in real time the number of viewable participants in a video conference.

Embodiments of the present invention provide for a video conference program 112 that dynamically creates groups of visible users in the video conference program 112 based on context (i.e., number of participants, presenters, stakeholders, meeting subject, participant interests, organizational structure, chat activity, user preferences, historical learning, or any combination). Embodiments of the present invention provide for a video conference program 112 that can arrange users in a template for viewing based on seating mapping tables, grid around frames of a video conference, list, etc. Embodiments of the present invention allow for a video conference program 112 to determine preferences for the display of the template based on user preferences, such as a scrollable list, around border of a video conference window, seating template mapping of number of participants, seating template mapping based on user preferences, etc.

As referred to herein, all data retrieved, collected, and used, is used in an opt in manner, i.e., the data provider has given permission for the data to be used. For example, the cognitive data received from a biometric watch would be based upon the approval of a request for said data. As another example, the system could request approval from the owner of the computing device before capturing audio and/or video. Any data or information used for which the provider has not opted in is data that is publicly available.

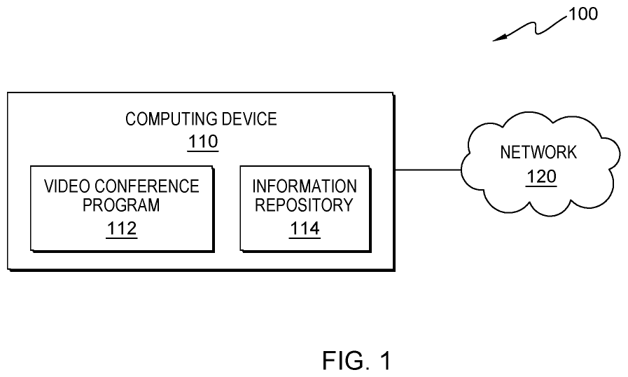

Referring now to various embodiments of the invention in more detail, FIG. 1 is a functional block diagram of a network computing environment, generally designated 100, suitable for operation of video conference program 112 in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes computing device 110 interconnected over network 120. In embodiments of the invention, network 120 can be a telecommunications network, a local area network (LAN), a wide area network (WAN), such as the Internet, or a combination of the three, and can include wired, wireless, or fiber optic connections. Network 120 may include one or more wired and/or wireless networks that are capable of receiving and transmitting data, voice, and/or video signals, including multimedia signals that include voice, data, and video formation. In general, network 120 may be any combination of connections and protocols that will support communications between computing device 110 and other computing devices (not shown) within network computing environment 100.

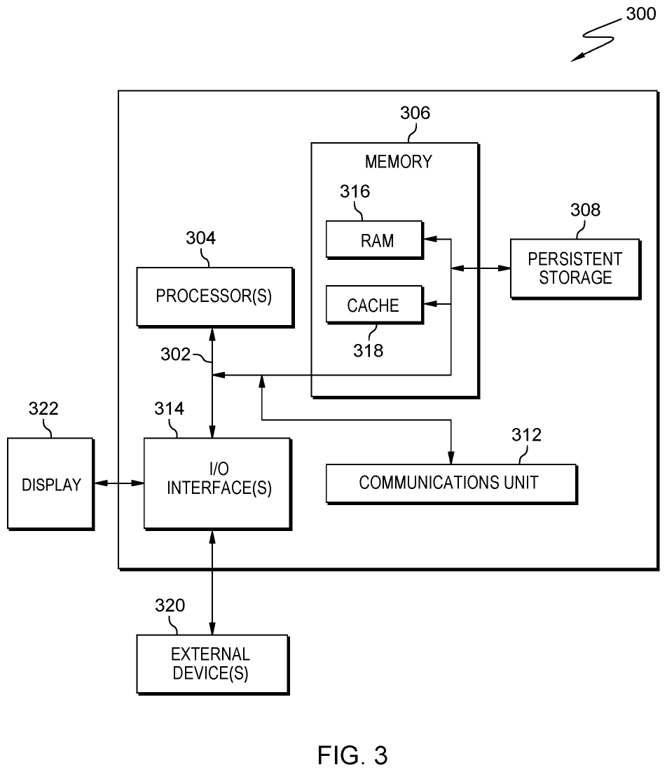

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with other computing devices (not shown) within computing environment 100 via a network, such as network 120. Computing device 110 may include internal and external hardware components, as depicted and described in further detail with respect to FIG. 3.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

Computing device 110 includes a user interface (not shown). A user interface is a program that provides an interface between a user and an application. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In various embodiments of the invention, computing device 110 includes video conference program 112 and information repository 114.

In an embodiment, video conference program 112 is depicted in FIG. 1 as being integrated with computing device 110. In alternative embodiments, video conference program 112 may be remotely located from computing device 110. For example, video conference program 112 can be integrated with another computing device (not shown) connected to network 120. Embodiments of the present invention provide for a video conference program 112 that provides multiple display arrangements for viewing participants of a video conference. In an embodiment, video conference program 112 may be a traditional video conferencing program that provides the reception of transmission of audio-video signals by multiple users using multiple devices in multiple locations. In this embodiment, video conference program 112 allows for an organization or group meeting that takes place using audio-video signals. In an alternative embodiment, video conference program 112 may work with another program, such as a traditional video conferencing program.

In embodiments of the present invention, video conference program 112 provides login verification. Video conference program 112 determines participants in the video conference. Video conference program 112 determines a dynamic subgroup of users. Video conference program 112 extracts an image of the users. Video conference program 112 creates a template. Video conference program 112 determines whether the template is acceptable based on input from the user. Video conference program 112 displays the template.

In an embodiment, computing device 110 includes information repository 114. In an embodiment, information repository 114 may be managed by video conference program 112. In an alternative embodiment, information repository 114 may be managed by the operating system of the device, another program (not shown), alone, or together with, video conference program 112. Information repository 114 is a data repository that can store, gather, and/or analyze information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided that information repository 114 is accessible by computing device 110. Information repository 114 includes, but is not limited to, login information, user preferences, grouping preferences, template preferences, historical data for users, facial and voice recognition data, 3D imaging data, participants invited to video conferences, and information about specific video conferences.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

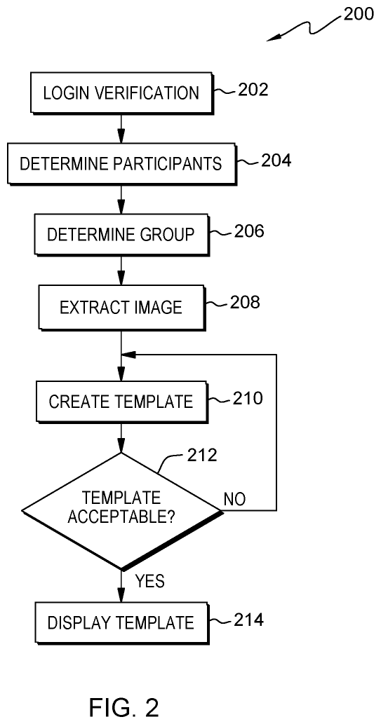

FIG. 2 is a flow chart diagram depicting operational steps of workflow 200 for video conference program 112 in accordance with at least one embodiment of the invention. In one embodiment, the steps of the workflow are performed by video conference program 112. In another embodiment, the steps of workflow 200 may be performed by any other program while working with video conference program 112. In yet another embodiment, the steps of workflow 200 may be integrated into another program while working with video conference program 112. For example, the steps of workflow 200 may be integrated into a traditional video conferencing program that provides the reception of transmission of audio-video signals by multiple users using multiple devices in multiple locations. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

Video conference program 112 provides login verification (step 202). At step 202, video conference program 112 receives login information from a user that is trying to join a video conference. In an embodiment, video conference program 112 receives login information in the form of a user identification and an associated password. In an embodiment, the user identification may be a username, a ClientID, login credentials, or any other form of identification that identifies the user. In an embodiment, each set of login information is associated exclusively with a single user. In an alternative embodiment, a set of login information may be associated with one or more users.

In step 202, video conference program 112 verifies the login information that is received. In an embodiment, video conference program 112 compares the login information received to the login information found in information repository 114. If the login information is incorrect, in other words the login information does not match the login information found in information repository 114, video conference program 112 notifies the user of the incorrect login information and processing of flow 200 ends. In this embodiment, the user may input login information again. If the login information is correct, video conference program 112 may notify the user via the user interface on the client device of the correct login information. In an embodiment, the login information may be for accessing video conference program 112. In an alternative embodiment, the login information may be for a specific video conference that is being performed using video conference program 112. In an embodiment, video conference program 112 determines user preferences for the user from information repository 114 based on the login information.

Video conference program 112 determines participants (step 204). At step S204, video conference program 112 determines the participants on the video conference. Here, video conference program 112 determines the video conference that the user is trying to participate in, via user interaction with video conference program 112. In an embodiment, video conference program 112 may have only a single video conference and that video conference is the one the user is trying to join. In an alternative embodiment, video conference program 112 may have multiple video conferences available and user input may be needed to determine the video conference the user is trying to join. In a first embodiment, the participants may be all participants on the video conference currently. In this embodiment, video conference program 112 will check periodically, based on a time interval, if new participants join the call. In a second embodiment, the participants may be all of the participants that were invited to the video conference. In a third embodiment, the participants may be determined by voice and/or facial recognition on the localized device (not shown) of each participant that is currently in the video conference.

Video conference program 112 determines a group of participants (step 206). At step S206, video conference program 112 determines a group of participants to display to the user based at least on the preferences of the user, the historical data for the user, and the determined participants. In an embodiment, the groups can be based on any of the following: number of participants, presenters, stakeholders, meeting subject, participant interests, organizational structure, chat activity, user preference rules, and historical learning. In an embodiment, the group of participants may be the same for each user viewing the video conference. In an alternative embodiment, the group of participants may be different for each user viewing the video conference.

In a first embodiment, video conference program 112 determines a group of participants based on the number of participants in the video conference. For example, if the number of participants is below a threshold (e.g., 6), and there are four participants, then the groups will be four individual boxes. In another example, if the number of participants above a threshold (e.g., 6) then the group will be a single circular grouping with all participants viewable.

In a second embodiment, video conference program 112 determines a group of participants based on the presenter. In this embodiment, the presenter includes in the information about video conference, specific users that should be in the group. In an alternative embodiment, video conference program 112 can use natural language processing to determine the presenters for the group of participants based on the details about the presentation. For example, the presenter may indicate that person A, person B, and person C should be in the group to be displayed when sending out a meeting invitation because person A, person B, and person C will be conducting the video conference.

In a third embodiment, video conference program 112 determines a group of participants based on the stakeholders. In this embodiment, included in the information about the video conference there are specific users that should be in the group. In an alternative embodiment, video conference program 112 can use natural language processing to determine the stakeholders for the group of participants based on the details about the presentation. For example, the information may indicate that Person A, the President of the Company and Person B, the Vice-President of the company should be in the group to be displayed.

In a fourth embodiment, video conference program 112 determines a group of participants based on the meeting subject. In an embodiment, video conference 112 can determine the meeting subject and then determine the group based is determined based on how similar the expertise of the participants is to the meeting subject. For example, if the meeting subject is “hypervisors”, the group may be determined to be all users who have a primary job role working with hypervisors. In an embodiment, video conference program 112 determines the participants based on the meeting subject based on historical learning, in other words based on the participants normally for the meeting subject. In an alternative embodiment, video program 112 determines the participants based on the meeting subject using natural language processing.

In a fifth embodiment, video conference program 112 determines a group of participants based on the participant interest. In this embodiment, the interests of the user are determined and then the interests of the participants is determined. Video conference program 112 determines a group of participants based on how similar the participants interests are to the interests of the user by using participant interest information found in information repository 114. For example, if the user is interested in soccer, all other participants that are interested in soccer will be determined to be in the group.

In a sixth embodiment, video conference program 112 determines a group of participants based on the organizational structure. For example, an organizational structure could be a team lead, the team, the manager, etc. Here, video conference program 112 could determine a group of participants to be all of the managers in the organizational structure. Alternatively, video conference program 112 could determine a group of participants to be all of the participants that are one to two levels above the user in the organizational structure.

In a seventh embodiment, video conference program 112 determines a group of participants based on historic chat activity. In this embodiment, video conference program 112 determines history chat activity of the user based on information found in information repository 114, and then determines the group of participants based on how often the user chats with specific participants. For example, historically User A always chats with Participant B and Participant C during video conferences, therefore, video conference program 112 determines the group of participants includes Participant B and Participant C. In this embodiment, chat may be a textual based conversation using computer programs via computers between two or more users.

In an eighth embodiment, video conference program 112 determines a group of participants based on user preferences. In this embodiment, video conference program 112 may determine the group of participants based on the user preferences found in information repository 114. For example, video conference program 112 may determine that the preferences of User A indicate that Participant A and Participant B are always in the group of participants for User A.

In a ninth embodiment, video conference program 112 determines a group of participants based on historical learning found in information repository. In an embodiment, the historical learning may be the participants that the user always adds to the group. For example, User A always adds Participant A and Participant B to the group of participants, therefore video conference program 112 determines the group of participants will include at least Participant A and Participant B.

In a tenth embodiment, video conference program 112 determines the group of participants based on the cognitive state of the user viewing the video conference. In this embodiment, sensors and/or devices (not shown) will measure the cognitive state of the user, including but not limited to, heart rate, facial expressions, body language, passive listening of user, etc. Video conference program 112 can use these measurements to determine the group of participants. For example, video conference program 112 may determine the user is nervous, and therefore video conference program 112 will have a smaller number of people in the group of participants.

In an eleventh embodiment, video conference program 112 may determine the group of participants based on any combination and/or all of the previous ten embodiments.

Video conference program 112 extracts an image (step 208). At step S208, video conference program 112 determines an extracted image of each participant in the determined group of participants. In a first embodiment, video conference program 112 receives an extracted image from the localized device (not shown) of each participant in the determined group of participants. In a second embodiment, video conference program 112 retrieves an extracted image that was saved to information repository 114 for each participant in the determine group of participants. In a third embodiment, video conference program 112 retrieves an extracted image for each participant from a remote server that manages images. In an embodiment, the extracted image may be the face of the participant. In an alternative embodiment, the extracted image may be the entire body of the participant. In an embodiment, the extracted image may be a 3D image.

Video conference program 112 creates a template (step 210). At step S210, video program 112 determines a template for display that includes the determined group of participants. In a first embodiment, each participant in the group of participants will also include the extracted image of each participant. In an alternative embodiment, one or more participants in the group of participants will also include their extracted image. In an embodiment, video conference program 112 creates a template based on indications from a user. In an embodiment, video conference program 112 creates a template with the determine group being displayed in a grid, round an outer edge of a video conference, mapped to seating template based on the number of participants, and/or mapped to seating a seating template based on user preferences.

In an embodiment, video conference program 112 creates the template based on the determined group of participants. In this embodiment, video conference program 112, based on the determined group of participants, will determine a template to use based on the preferences found in information repository 114. In a first example, video conference program 112 may determine there were four people in the determined group of participants. In this example, video conference program 112 may determine the preferences for the template when there are less than five people in the group is to setup the template in a grid form with each person in a square in the grid. In a second example, video conference program 112 may determine there are twelve people in the determined group of participants. In this example, video conference program 112 may determine the preference for the template when there are more than five people in the group is to setup the template in a round table setup with each person having a seat at the round table. In this example, video conference program 112 may also determine that the preferences for over five people is to have a 3D image of each person at each seat of the round table. In a third example, video conference program 112 may determine that the determined group is based on an organizational structure. In this example, video conference program 112 may determine to put the highest ranking member of the organization structure at the head of the table, and then each other member of the group around the table based on their significance in the organization structure. In a fourth example, the user of video conference program 112 may have preferences that a certain template is always used for certain circumstances.

In an embodiment, video conference program 112 creates the template using the extruded image. In this embodiment, video conference program 112 will receive, while the video conference is in progress, the facial image of the determined group of participants from camera and/or imaging devices (not shown) on the computing device of the participant. In this embodiment, video conference program 112 or another program, not shown, will identify the facial image and visible body portions of each participant in the determined group, and accordingly the real-time facial image will be plodded in the seating template. In an embodiment, video conference program 112 or another program, not shown, using object boundary recognition, will extract the face of each participant in the determined group. In an embodiment, a 3D facial image and visible body parts may be constructed for each participant in the determined group using multiple cameras. In an embodiment, video conference program 112 or another program, not shown, will plot the extruded images in the template. In an embodiment, video conference program 112 or another program, not shown, will continually track and plot the real-time extracted facial image and visible body parts of the determined group of participants in the template. In an embodiment, the dimension of the visible body parts and facial image will be calculated dynamically based on the relative distance of the participants from the camera. In this embodiment, people seating far away from a person will be shown smaller in dimension of facial image.

Video conference program 112 determines whether the template is acceptable (decision step 212). In step S212, Video conference program 112 provides a draft version of the template to the user. If video conference program 112 receives an indication of approval of the draft version of the template, video conference program displays the template (step 214). If video conference program 112 receives an indication of disapproval, video conference program returns to create another template (step 210). In an embodiment, the indication of disapproval can include information on how to modify the template. For example, the user may indicate another person to replace a person in the group in the template. In an alternate example, the user may indicate another person to add to the group in the template. In yet another example, the user may indicate a grid view in the template as opposed to the current view.

Video conference program 112 displays the template (step 214). At step S214, video conference program 112 displays the approved template for viewing in the user interface of video conference program 112. In an alternative embodiment, video conference program 112 can indicate to any other program that is video conferencing of the preferred template for display in the other program.

In an embodiment, video conference program 112 performs the steps of workflow 200 in the order that the numerical order they are listed. In an alternative embodiment, video conference program 112 performs one or more of the steps simultaneously. For example, video conference program 112 may be performing step 210, however video conference program may determine that a new participant has joined the video conference (step 204), therefore video conference program 112 may determine a new group (step 206) causing other changes to steps in workflow. In another example, video conference program 112 may be performing step 214, however video conference program 112 determines that the cognitive state of the user has changed, therefore video conference program may perform step 210 and create a new template. In another embodiment, video conference program 112 can perform workflow 200 as an initial setup for the video conference, and then video conference program 112 can perform any and/or all of the steps based on an indication from the user. In yet another embodiment, video conference program 112 can perform workflow 200 as an initial setup for the video conference, and then video conference program 112 can perform any and/or all of the steps based on a time interval (i.e., 1 minute, 5 minutes, 20 minutes).

FIG. 3 is a block diagram depicting components of a computer 300 suitable for video conference program 112, in accordance with at least one embodiment of the invention. FIG. 3 displays the computer 300, one or more processor(s) 304 (including one or more computer processors), a communications fabric 302, a memory 306 including, a RAM 316, and a cache 318, a persistent storage 308, a communications unit 312, I/O interfaces 314, a display 322, and external devices 320. It should be appreciated that FIG. 3 provides only an illustration of one embodiment and does not imply any limitations with regard to the environments in which different embodiments may be implemented. Many modifications to the depicted environment may be made.

As depicted, the computer 300 operates over the communications fabric 302, which provides communications between the computer processor(s) 304, memory 306, persistent storage 308, communications unit 312, and input/output (I/O) interface(s) 314. The communications fabric 302 may be implemented with an architecture suitable for passing data or control information between the processors 304 (e.g., microprocessors, communications processors, and network processors), the memory 306, the external devices 320, and any other hardware components within a system. For example, the communications fabric 302 may be implemented with one or more buses.

The memory 306 and persistent storage 308 are computer readable storage media. In the depicted embodiment, the memory 306 comprises a random-access memory (RAM) 316 and a cache 318. In general, the memory 306 may comprise any suitable volatile or non-volatile one or more computer readable storage media.

Program instructions for video conference program 112 may be stored in the persistent storage 308, or more generally, any computer readable storage media, for execution by one or more of the respective computer processors 304 via one or more memories of the memory 306. The persistent storage 308 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of the persistent storage 308.

The communications unit 312, in these examples, provides for communications with other data processing systems or devices. In these examples, the communications unit 312 may comprise one or more network interface cards. The communications unit 312 may provide communications through the use of either or both physical and wireless communications links. In the context of some embodiments of the present invention, the source of the various input data may be physically remote to the computer 300 such that the input data may be received, and the output similarly transmitted via the communications unit 312.

The I/O interface(s) 314 allow for input and output of data with other devices that may operate in conjunction with the computer 300. For example, the I/O interface 314 may provide a connection to the external devices 320, which may be as a keyboard, keypad, a touch screen, or other suitable input devices. External devices 320 may also include portable computer readable storage media, for example thumb drives, portable optical or magnetic disks, and memory cards. Software and data used to practice embodiments of the present invention may be stored on such portable computer readable storage media and may be loaded onto the persistent storage 308 via the I/O interface(s) 314. The I/O interface(s) 314 may similarly connect to a display 322. The display 322 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for video conferencing, the method comprising the steps of:
determining, by one or more computer processors, a video conference, wherein the video conference includes a first user and a plurality of participants;
determining, by the one or more computer processors, a first group of participants from the plurality of participants, wherein the first group is determined by using natural language processing to determine the meeting subject and determining the first group of participants based on the plurality of participants that have a job role in the determined meeting subject;
creating, by the one or more computer processors, a template for the video conference, wherein the template displays at least the first group of participants; and
displaying, by the one or more computer processors, the template in a user interface of the video conference.

2. The method of claim 1, further comprising:
providing, by the one or more computer processors, the template to the first user;
receiving, by the one or more computer processors, an indication from the first user; and
wherein the step of displaying, by the one or more computer processors, the template in the user interface of the video conference comprises:
responsive to the indication being approval, displaying, by the one or more computer processors, the template in the user interface of the video conference.

3. The method of claim 1, further comprising:
extracting, by the one or more computer processors, a 3D image of each participant of the first group of participants; and
wherein the step of creating, by the one or more computer processors, a template for the video conference, wherein the template is displayed in the video conference, and wherein the template displays at least the first group of participants comprises:
creating, by the one or more computer processors, the template for the video conference, wherein the template is displayed in the video conference, and wherein the template displays at least the first group of participants, and wherein each participant of the first group of participants is represented by their extracted 3D image.

4. (canceled)

5. (canceled)

6. (canceled)

7. (canceled)

8. A computer program product for video conferencing, the computer program product comprising:
one or more computer readable storage media; and
program instructions stored on the one or more computer readable storage media, the program instructions comprising:
program instructions to determine a video conference, wherein the video conference includes a first user and a plurality of participants;
program instructions to determine a first group of participants from the plurality of participants, wherein the first group is determined by using natural language processing to determine the meeting subject and determining the first group of participants based on the plurality of participants that have a job role in the determined meeting subject;
program instructions to create a template for the video conference, wherein the template displays at least the first group of participants;
program instructions to display the template in a user interface of the video conference.

9. The computer program product of claim 8, further comprising program instructions, stored on the one or more computer readable storage media, to:
provide the template to the first user;
receive an indication from the first user; and
wherein the program instructions to display the template in the user interface of the video conference comprises:
responsive to the indication being approval, display the template in the user interface of the video conference.

10. The computer program product of claim 8, further comprising program instructions, stored on the one or more computer readable storage media, to:
extract a 3D image of each participant of the first group of participants; and
wherein the program instructions to create a template for the video conference, wherein the template is displayed in the video conference, and wherein the template displays at least the first group of participants comprises:
create the template for the video conference, wherein the template is displayed in the video conference, and wherein the template displays at least the first group of participants, and wherein each participant of the first group of participants is represented by their extracted 3D image.

11. (canceled)

12. (canceled)

13. (canceled)

14. (canceled)

15. A computer system for video conferencing, the computer system comprising:
one or more computer processors;
one or more computer readable storage media; and
program instructions stored on the one or more computer readable storage media for execution by at least one of the one or more computer processors, the program instructions comprising:
program instructions to determine a video conference, wherein the video conference includes a first user and a plurality of participants;
program instructions to determine a first group of participants from the plurality of participants, wherein the first group is determined by using natural language processing to determine the meeting subject and determining the first group of participants based on the plurality of participants that have a job role in the determined meeting subject;
program instructions to create a template for the video conference, wherein the template displays at least the first group of participants;
program instructions to display the template in a user interface of the video conference.

16. The computer system of claim 15, further comprising program instructions stored on the one or more computer readable storage media for execution by at least one of the one or more computer processors, to:
provide the template to the first user;
receive an indication from the first user; and
wherein the program instructions to display the template in the user interface of the video conference comprises:
responsive to the indication being approval, display the template in the user interface of the video conference.

17. The computer system of claim 15, further comprising program instructions stored on the one or more computer readable storage media for execution by at least one of the one or more computer processors, to:
extract a 3D image of each participant of the first group of participants; and
wherein the program instructions to create a template for the video conference, wherein the template is displayed in the video conference, and wherein the template displays at least the first group of participants comprises:
create the template for the video conference, wherein the template is displayed in the video conference, and wherein the template displays at least the first group of participants, and wherein each participant of the first group of participants is represented by their extracted 3D image.

18. (canceled)

19. (canceled)

20. (canceled)
